(19) United States
(12) Patent Application Publication
(10) Pub. No.: US 2022/0334839 A1
(43) Pub. Date: Oct. 20, 2022

(54) PROJECTION ALGORITHMS FOR DISCRETE FOURIER TRANSFORM TWIDDLE FACTORS GENERATION

(71) Applicants: Firas Abdullah Al-Saedi, Secaucus, NJ (US); Ahmed Najah Jabbar, Hilla (IQ)

(72) Inventors: Firas Abdullah Al-Saedi, Secaucus, NJ (US); Ahmed Najah Jabbar, Hilla (IQ)

(21) Appl. No.: 17/216,904

(22) Filed: Mar. 30, 2021

(51) Int. Cl. G06F 9/30; G06F 17/14; G06F 16/901

(52) U.S. Cl. CPC G06F 9/30036; G06F 9/3001; G06F 17/141; G06F 16/9017

(57) ABSTRACT

The present invention is related to Discrete Fourier Transform (DFT) Twiddle Factors (TFs) generation algorithms. It presents New Projection Algorithms (NPAs) to generate any required TF of the DFT matrix by providing only a small stored portion of the TFs that are stored in a Memory Storage (MS). The present invention presents how to exploit the existence of symmetries and the existence of similarities among the TFs of the DFT matrix to construct a methodology of operation to be able to formulate the NPAs. The use of the NPAs will avoid the need of retrieving that required TF from pre-saved lookup tables of the DFT matrix and also will avoid the need to calculate it with slow complicated algorithms like CORDIC as used by prior arts.

### FIELD OF THE INVENTION

The present invention is related to Discrete Fourier Transform (DFT) Twiddle Factors (TFs) generation algorithms.

Preferred embodiments of the present invention deal with DFT TFs generation algorithms, more particularly with DFT TFs New Projection Algorithms (NPAs) and methods for generating any Twiddle Factor (TF) of the DFT matrix.

### BACKGROUND OF THE INVENTION

In conventional systems, all TFs of the DFT matrix should be pre-calculated and stored in a Memory Storage (MS) as lookup tables.

Storing all TFs requires large hardware MS space requirements that consumes extra power to maintain their stored values.

Another approach to generate the DFT matrix is by calculating the needed TFs using complicated algorithms like COordinate Rotation DIgital Computer (CORDIC). These algorithms consume time and require heavy calculations.

Using the proposed DFT TFs NPAs will eliminate the need to store the complete lookup tables for all TFs, hence; increasing the efficiency from the MS requirements perspective. Also, they eliminate the need for using slow complicated algorithms like CORDIC.

The DFT TFs NPAs of the present invention will generate any required TF of the DFT matrix.

The need to retrieve the required TF from pre-saved lookup tables of the DFT matrix is avoided; hence, avoiding the need to calculate it with slow complicated algorithms like CORDIC as implemented by prior arts.

In order to get the maximum performance of the DFT TFs NPAs of the present invention, it is preferred to be implemented using Field Programmable Gate Arrays (FPGA), parallel architecture Application Specific Integrated Circuit (ASIC) and/or other platforms having the capability of actual parallel processing for real time applications.

The DFT TFs NPAs of the present invention are very efficient due to their low hardware requirements, high speed and low power consumption.

Such efficiency is vital for real time computation of the DFT with massive number of samples to be transformed from time domain to frequency domain.

The present invention addresses these needs.

### SUMMARY OF THE INVENTION

The object of the present invention is to overcome the above disadvantages and to provide DFT TFs NPAs.

The NPAs are very efficient due to their low MS requirements, high speed and low power consumption.

Such efficiency is vital for real time DFT applications for massive number of samples transformation from time domain to frequency domain.

The thorough exploitation of the TFs symmetries and similarities is the backbone concept of the operation of the present invention.

The present invention presents how to exploit these symmetries and similarities to construct a methodology of operation to be able to formulate the NPAs. The NPAs will generate any required TF of the DFT without the need to retrieve that TF from pre-saved lookup tables of the DFT matrix. Also, will avoid the need to calculate it with slow complicated algorithms like CORDIC as used by prior arts.

The NPAs of the present invention will generate the required TF of the DFT matrix by providing only a small stored portion of the TFs that is stored in an MS.

In the present invention, N denotes the number of samples in the time domain to be transformed to frequency domain using DFT.

In Embodiment-1 (EMB-1) of FIG. 1 of the present invention, one Projection Equation (PE) and its New Projection Algorithm (NPA) (NPA-1) are presented.

It requires only N stored TFs in an MS to generate any required TF of the DFT matrix. The NPA-1 works for any odd or even value of N. The NPA-1 will reduce the MS requirements by a factor of

$$( 1 - \frac{1}{N} ) \times 100 \% ∀ N ∈ {ρ}_{1} = \{ {ℕ}^{+} , ( 2 \times {ℕ}^{+} ) \} . {ℕ}^{+}$$

is the positive natural numbers {1, 2, 3, . . . }.

In Embodiment-2 (EMB-2) of FIG. 2 of the present invention, two Projection Equations (PEs) and their NPA (NPA-2) are presented.

The NPA-2 requires

$$( ⌊ \frac{N}{2} ⌋ + 1 )$$

stored TFs in an MS to generate any required TF of the DFT matrix. The NPA-2 works for any odd or even value of N. The NPA-2 will reduce the MS requirements by a factor of

$$( 1 - \frac{( ⌊ \frac{N}{2} ⌋ + 1 )}{{N}^{2}} ) \times 100 \% ∀ N ∈ {ρ}_{1} .$$

In Embodiment-3 (EMB-3) of FIG. 3 of the present invention, five PEs and their related NPA (NPA-3) are presented.

The NPA-3 requires only

$$( \frac{N}{2} + 1 )$$

stored TFs in an MS to generate any required TF of the DFT matrix. The NPA-3 works only for even values of N. The NPA-3 will reduce the MS requirements by a factor of

$$( 1 - \frac{( \frac{N}{2} + 1 )}{{N}^{2}} ) \times 100 \% ∀ N ∈ {ρ}_{2} = \{ 2 \times {ℕ}^{+} \} .$$

In Embodiment-4 (EMB-4) of FIG. 4 of the present invention, six PEs and their NPA (NPA-4) are presented.

The NPA-4 requires only

$$( ⌊ \frac{N}{4} ⌋ + 1 )$$

stored TFs in an MS to generate any required TF of the DFT matrix. The NPA-4 works only for even values of N. The NPA-4 will reduce the MS requirements by a factor of

$$( 1 - \frac{( ⌊ \frac{N}{4} ⌋ + 1 )}{{N}^{2}} ) \times 100 \% ∀ N ∈ {ρ}_{2} .$$

The present invention can be implemented using the powerful capabilities of the actual parallel processing platforms like FPGA, ASIC and/or other platforms. Using such platforms employ the strength of actual parallel processing computation for real time applications.

### BRIEF DESCRIPTION OF THE DRAWINGS

FIG. 1 is the schematic block diagram of operation of EMB-1 of the present invention.

FIG. 2 is the schematic block diagram of operation of EMB-2 of the present invention.

FIG. 3 is the schematic block diagram of operation of EMB-3 of the present invention.

FIG. 4 is the schematic block diagram of operation of EMB-4 of the present invention.

FIG. 5 is the flowchart diagram of the NPA-1 of EMB-1 of the present invention.

FIG. 6 is the flowchart diagram of the NPA-2 of EMB-2 of the present invention.

FIG. 7 is the flowchart diagram of the NPA-3 of EMB-3 of the present invention.

FIG. 8 is the flowchart diagram of the NPA-4 of EMB-4 of the present invention.

FIG. 9 is the simulated comparison result plot of the Minimum Number of Required TFs (MNRTF) computations (logarithmic scale) versus the number of points N (logarithmic scale) for the NPA-1 of EMB-1, the NPA-2 of EMB-2, the NPA-3 of EMB-3, the NPA-4 of EMB-4 of the present invention and the DFT.

FIG. 10 is the simulated comparison result plot of the MNRTF computations (logarithmic scale) versus the number of points N (linear scale) for the NPA-1 of EMB-1, the NPA-2 of EMB-2, the NPA-3 of EMB-3, the NPA-4 of EMB-4 of the present invention and the DFT.

FIG. 11 is the simulated comparison result plot of the Twiddles Percentage Ratio (TPR) of the MNRTF computations (logarithmic scale) versus the number of points N (logarithmic scale) for the NPA-1 of EMB-1, the NPA-2 of EMB-2, the NPA-3 of EMB-3, the NPA-4 of EMB-4 of the present invention and the DFT.

FIG. 12 is the simulated comparison result plot of the TPR of the MNRTF computations (logarithmic scale) versus the number of points N (linear scale) for the NPA-1 of EMB-1, the NPA-2 of EMB-2, the NPA-3 of EMB-3, the NPA-4 of EMB-4 of the present invention and the DFT.

FIG. 13 is the simulated comparison result plot of the Percentage Memory Reduction Ratio (PMRR) computations (linear scale) versus the number of points N (logarithmic scale) for the NPA-1 of EMB-1, the NPA-2 of EMB-2, the NPA-3 of EMB-3, the NPA-4 of EMB-4 of the present invention and the DFT.

### DETAILED DESCRIPTION OF THE PREFERRED EMBODIMENTS

The N complex valued numbers, generated by the DFT for the time-sampled signal xₙ, are shown in Eq.(1).

$${X}_{k} = {\sum }_{n = 0}^{N - 1} {X}_{n} \times {e}^{( \frac{- j 2 π \times ( n \times k )}{N} )} = {\sum }_{n = 0}^{N - 1} {X}_{n} \times {W}_{N}^{( n \times k )} \\ ∀ n , k ∈ ψ = \{ 0 , 1 , 2 , … , ( N ‐ 1 ) \} ∧ ∀ N ∈ {ρ}_{1} ∧ ∀ {X}_{k} , {x}_{n} ∈ ℂ \qquad ( 1 )$$

The N complex valued numbers generated by the Inverse DFT (IDFT) for the frequency-sampled Xₖ are shown in Eq.(2).

$${X}_{n} = {\sum }_{k = 0}^{N - 1} {X}_{k} \times {e}^{( \frac{j 2 π \times ( n \times k )}{N} )} = {\sum }_{k = 0}^{N - 1} {X}_{k} \times {W}_{N}^{( - ( n \times k ) )} \\ ∀ n , k ∈ ψ ∧ ∀ N ∈ {ρ}_{1} ∧ ∀ {X}_{k} , {x}_{n} ∈ ℂ \qquad ( 2 )$$

where:

Xₖ are the frequency harmonics.

xₙ are the signal time samples.

k is the index in the frequency domain.

n is the index in the time domain.

[symbol] is a complex number.

j=\sqrt{−1}.

Equation (3) presents W_{N}, which is the principal N^{th} root of unity of Eq.(1) and Eq.(2).

$${W}_{N} = {e}^{( \frac{- j 2 π}{N} )} = cos ( \frac{2 π}{N} ) - j sin ( \frac{2 π}{N} ) \\ ∀ N ∈ {ρ}_{1} ∧ ∀ {W}_{N} ∈ ℂ \qquad ( 3 )$$

The matrix form of Eq.(1) is shown in Eq.(4). Equation (4) shows the DFT matrix.

The compact DFT matrix form of Eq.(4) is shown in Eq.(5).

$$[ \begin{matrix}{X}_{0} \\ {X}_{1} \\ {X}_{2} \\ ⋮ \\ {X}_{N - 1}\end{matrix} ] = [ \begin{matrix}{W}_{N}^{( 0 \times 0 )} & {W}_{N}^{( 0 \times 1 )} & {W}_{N}^{( 0 \times 2 )} & … & {W}_{N}^{( 0 \times ( N - 1 ) )} \\ {W}_{N}^{( 1 \times 0 )} & {W}_{N}^{( 1 \times 1 )} & {W}_{N}^{( 1 \times 2 )} & … & {W}_{N}^{( 1 \times ( N - 1 ) )} \\ {W}_{N}^{( 2 \times 0 )} & {W}_{N}^{( 2 \times 1 )} & {W}_{N}^{( 2 \times 2 )} & … & {W}_{N}^{( 2 \times ( N - 1 ) )} \\ ⋮ & ⋮ & ⋮ & ⋱ & ⋮ \\ {W}_{N}^{( ( N - 1 ) \times 0 )} & {W}_{N}^{( ( N - 1 ) \times 1 )} & {W}_{N}^{( ( N - 1 ) \times 2 )} & … & {W}_{N}^{( ( N - 1 ) \times ( N - 1 ) )}\end{matrix} ] \times \\ [ \begin{matrix}{x}_{0} \\ {x}_{1} \\ {x}_{2} \\ ⋮ \\ {x}_{N - 1}\end{matrix} ] ∀ X , x , {W}_{N} ∈ ℂ ∧ ∀ N ∈ {ρ}_{1} \qquad ( 4 )$$

$$[ \begin{matrix}{x}_{0} \\ {x}_{1} \\ {x}_{2} \\ ⋮ \\ {x}_{N - 1}\end{matrix} ] = [ \begin{matrix}{W}_{N}^{( 0 )} & {W}_{N}^{( 0 )} & {W}_{N}^{( 0 )} & … & {W}_{N}^{( 0 )} \\ {W}_{N}^{( 0 )} & {W}_{N}^{( 1 )} & {W}_{N}^{( 2 )} & … & {W}_{N}^{( N - 1 )} \\ {W}_{N}^{( 0 )} & {W}_{N}^{( 2 )} & {W}_{N}^{( 4 )} & … & {W}_{N}^{( 2 \times ( N - 1 ) )} \\ ⋮ & ⋮ & ⋮ & ⋱ & ⋮ \\ {W}_{N}^{( 0 )} & {W}_{N}^{( ( N - 1 ) \times 1 )} & {W}_{N}^{( ( N - 1 ) \times 2 )} & … & {W}_{N}^{( ( N - 1 ) \times ( N - 1 ) )}\end{matrix} ] \times \\ [ \begin{matrix}{x}_{0} \\ {x}_{1} \\ {x}_{2} \\ ⋮ \\ {x}_{N - 1}\end{matrix} ] ∀ X , x , {W}_{N} ∈ ℂ ∧ ∀ N ∈ {ρ}_{1} \qquad ( 5 )$$

When an integer number A is divided by another integer number B as shown in Eq.(6), the modulo's operation result is the remainder R. The modulo operator is denoted by the [symbol] symbol as presented in Eq.(7).

$$\frac{A}{B} = Q and the remainder is R \qquad ( 6 )$$

$${B}_{( A )}^{} = R \qquad ( 7 )$$

Where:

A is the dividend, A ∈ [symbol] ={ . . . , −2, −1, 0, 1, 2, . . . }.

B is the divisor, B ∈ [symbol] \{0}.

Q is the quotient, Q ∈ [symbol] .

R is the remainder, R ∈ φ={0, 1, 2, . . . , (B−1)}.

### Embodiment-1

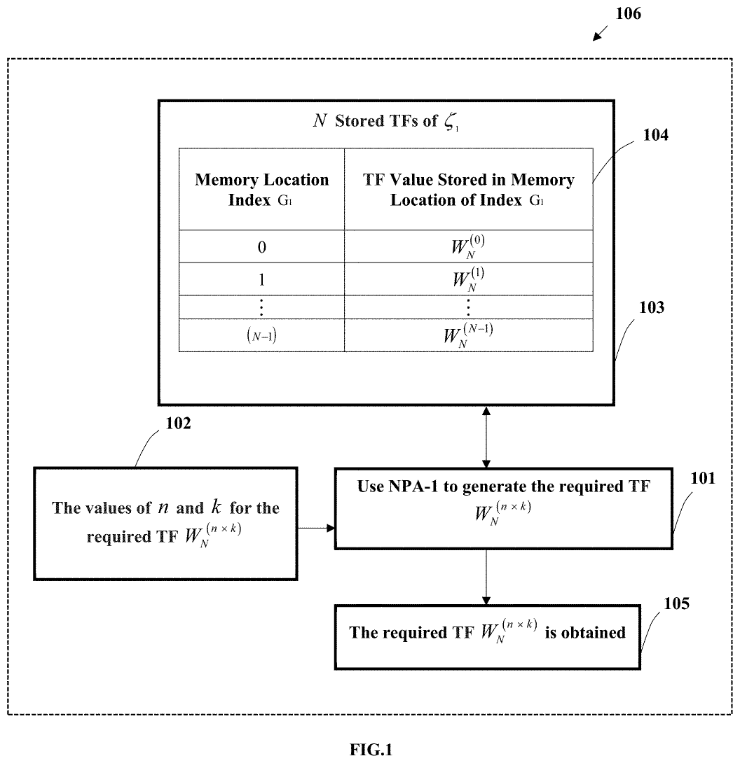

In EMB-1 106 of the present invention as shown in FIG. 1, we are going to find the formulation for the NPA-1 101 that will enable us to generate any required TF W_{N}^{(n×k)} 102 of the DFT matrix.

Instead of storing the N² TFs that are needed to calculate the DFT which require large MS requirements, only N TFs that are members of the set ζ₁{W_{N}⁽⁰⁾, W_{N}⁽¹⁾, . . . , W_{N}^{(N-1)}} ∀N∈ρ₁\hat{ }∀W_{N}∈ [symbol] are needed to be stored in an MS 103.

The NPA-1 101 will be used to project a specific value to the required TF W_{N}^{(n×k)} 102 from one of the N TFs of the ζ₁ 104 vector that is stored in an MS 103.

The outcome 105 of the NPA-1 101 will be the projected required TF W_{N}^{(n×k)} 102.

The NPA-1 PE formulation is presented below.

The property shown in Eq.(8) is the PE of EMB-1 106 and it will be used to design the NPA-1.

W_{N}^{(n×k)=} [symbol] (8)

∀n,k, [symbol] _{N}^{(n×k)}∈ψ\hat{ }∀N∈ρ₁\hat{ }∀W_{N}∈

[symbol]

By using Eq.(8), we can project a specific value to the required TF W_{N}^{(n×k)} 102 from one of the N TFs of the ζ₁ 104 vector.

The MS arrangement of the NPA-1 is presented below.

FIG. 1 shows how the elements of the set ζ₁ are pre-calculated, arranged and stored in an MS 103 to construct the ζ₁ 104 TFs vector.

The N elements of the ζ₁ 104 TFs vector are constructed according to Eq.(9).

$${ζ}_{1} [ {G}_{1} ] = {W}_{N}^{( {G}_{1} )} = cos ( \frac{2 π}{N} \times {G}_{1} ) - j sin ( \frac{2 π}{N} \times {G}_{1} ) ∀ {G}_{1} ∈ ψ ∧ ∀ N ∈ {ρ}_{1} ∧ ∀ {W}_{N} ∈ ℂ \qquad ( 9 )$$

The memory location index of the ζ₁ 104 TFs vector is G₁.

The NPA-1 101 is connected to the ζ₁ 104 TFs vector that is stored in an MS 103.

From Eq.(8) and Eq.(9), the NPA-1 101 of EMB-1 106 of the present invention is realized as shown in the flowchart of FIG. 5. The operation steps of the flowchart of the NPA-1 101 are presented below.

The flowchart of FIG. 5 starts at step 501; then, step 502 will read the values of n and k for the required TF W_{N}^{(n×k)} 102.

Step 503 will calculate the value of [symbol] _{N}^{(n×k)} using Eq.(7).

Step 504 will read the value of the TF stored in the memory location of index [symbol] _{N}^{(n×k)} of the ζ₁ 104 TFs vector.

According to Eq.(10), Step 505 will project and assign the value of ζ₁[ [symbol] _{N}^{(n×k)}] to the required TF W_{N}^{(n×k)} 102.

W_{N}^{(n×k)}=ζ₁[ [symbol] _{N}^{(n×k)}] (10)

∀n,k, [symbol] _{N}^{(n×k)}∈ψ\hat{ }∀N∈ρ₁\hat{ }∀W_{N}∈

[symbol]

The NPA-1 101 is ended at step 506.

### Embodiment-2

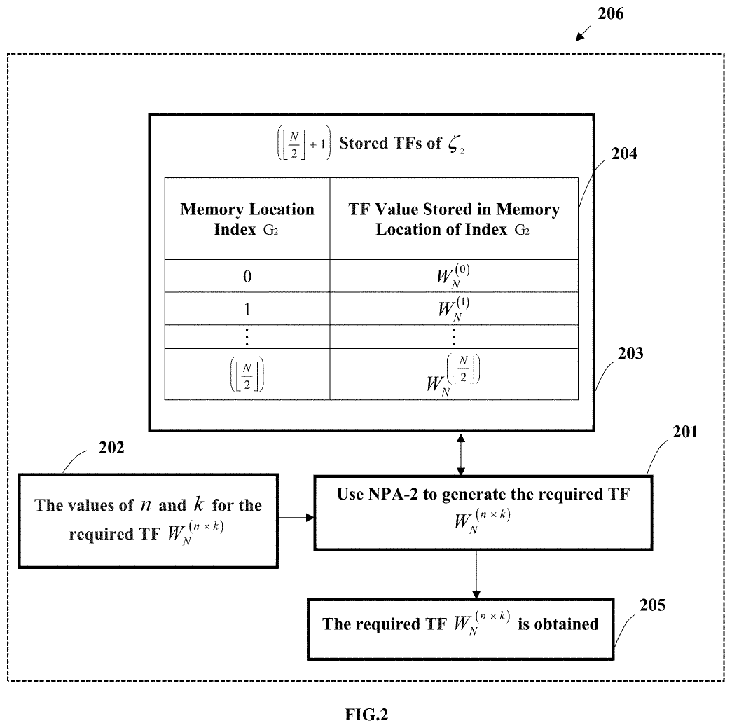

In EMB-2 206 of the present invention as shown in FIG. 2, we are going to find the formulation for the NPA-2 201 that will enable us to generate any required TF W_{N}^{(n×k)} 202 of the DFT matrix.

Instead of storing the N² TFs that are needed to calculate the DFT which require large MS requirements, only

$$( ⌊ \frac{N}{2} ⌋ + 1 )$$

TFs that are members of the set

$${ζ}_{2} = \{ {W}_{N}^{( 0 )} , {W}_{N}^{( 1 )} , … , {W}_{N}^{( ⌊ \frac{N}{2} ⌋ )} \}$$

∀N∈ρ₁\hat{ }∀W_{N}∈ [symbol] are needed to be stored in an MS 203.

The NPA-2 201 will be used to project a specific value to the required TF W_{N}^{(n×k)} 202 from one of the

$$( ⌊ \frac{N}{2} ⌋ + 1 )$$

TFs of the ζ₂ 204 vector that is stored in an MS 203.

The outcome 205 of the NPA-2 201 will be the projected required TF W_{N}^{(n×k)} 202.

The NPA-2 201 PEs formulation is presented below.

We have the property of Eq.(11).

W_{N}^{(-(n×k))}=(W_{N}^{(n×k)}*= [symbol] (11)

∀n,k, [symbol] _{N}^{(n×k)}∈ψ\hat{ }∀N∈ρ₁\hat{ }∀W_{N}∈

[symbol]

From Eq.(8) and Eq.(11), we can get Eq.(12).

W_{N}^{(n×k)}= [symbol] =( [symbol] )* (12)

∀n,k, [symbol] _{N}^{(n×k)}∈ψ\hat{ }∀N∈ρ₁\hat{ }∀W_{N}∈

[symbol]

Let

$${H}^{( n \times k )}$$

be defined as shown in Eq.(13).

$${H}^{( n \times k )} = 1 - ( ⌊ ⌋ ) = \{ \begin{matrix}1 & ⇐ & ∀ {N}_{( n \times k )}^{} & ∈ \\ 0 & ⇐ & ∀ {N}_{( n \times k )}^{} & ∈\end{matrix} \begin{matrix}{β}_{1} = \{ 0 , 1 , 2 , … , ( ⌊ \frac{N}{2} ⌋ ) \} \\ {β}_{2} = \{ ( ⌊ \frac{N}{2} ⌋ + 1 ) , ( ⌊ \frac{N}{2} ⌋ + 2 ) , … , ( N - 1 ) \}\end{matrix} \qquad ( 13 )$$

$$∀ n , k , {N}_{( n \times k )}^{} ∈ ψ ⋀ ∀ N ∈ {ρ}_{1} ⋀ ∀ {W}_{N} ∈$$

Where └ ┘ is the floor symbol. └ [symbol] ┘ is the floor of [symbol] that is the nearest integer ≤ [symbol] .

Using Eq.(12) and Eq.(13), we can get Eq.(14).

$${W}_{N}^{( n \times k )} = \{ \begin{matrix} & = & {( )}^{⋆} & ⇐ ∀ {H}^{( n \times k )} = 1 \\ & = & {( )}^{⋆} & ⇐ ∀ {H}^{( n \times k )} = 0\end{matrix} \qquad ( 14 )$$

$$∀ n , k , {N}_{( n \times k )}^{} ∈ ψ ⋀ ∀ N ∈ {ρ}_{1} ⋀ ∀ {W}_{N} ∈$$

From examining Table 1, we can clearly notice that by only storing

$$( ⌊ \frac{N}{2} ⌋ + 1 )$$

TFs of the ζ₂ 204 vector in an MS 203, we can generate any required TF W_{N}^{(n×k)} 202 of the DFT matrix.

From Eq.(14) and Table 1, we can get Eq.(15) that shows the two PEs of EMB-2 206 that will be used to design the NPA-2 201. Equation (15) can be used to generate any required TF W_{N}^{(n×k)} 202.

TABLE 1
$Does δ ∈ {Ϛ}_{2} ? \vert ∀ {H}^{( n \times k )} = 1 ⋀ ∀ {H}^{( n \times k )} = 0 ⋀ ∀ n , k , {N}_{( n \times k )}^{} ∈ ψ ⋀ ∀ N ∈ {ρ}_{1} ⋀ {W}_{N} ∈$

| # | δ | $∀ {H}^{( n \times k )} = 1$ | $∀ {H}^{( n \times k )} = 0$ |
|---|---|---|---|
| 1 | [symbol] | Yes | No |
| 2 | ( [symbol] )* | No | Yes |

$${W}_{N}^{( n \times k )} = \{ \begin{matrix} & ⇐ ∀ {H}^{( n \times k )} = 1 \\ {( )}^{⋆} & ⇐ ∀ {H}^{( n \times k )} = 0\end{matrix} \qquad ( 15 )$$

$$∀ n , k , {N}_{( n \times k )}^{} ∈ ψ ⋀ ∀ N ∈ {ρ}_{1} ⋀ ∀ {W}_{N} ∈$$

By using Eq.(15), we can project a specific value to the required TF W_{N}^{(n×k)} 202 from one of the

$$( ⌊ \frac{N}{2} ⌋ + 1 )$$

TFs of the ζ₂ 204 vector.

The MS arrangement of the NPA-2 201 is presented below.

FIG. 2 shows how the elements of the set ζ₂ are pre-calculated, arranged and stored in an MS 203 to construct the ζ₂ 204 TFs vector.

$$( ⌊ \frac{N}{2} ⌋ + 1 )$$

The elements of the ζ₂ 204 TFs vector are constructed according to Eq.(16).

$${ζ}_{2} [ {G}_{2} ] = {W}_{N}^{( G 2 )} = cos ( \frac{2 π}{N} \times {G}_{2} ) - j sin ( \frac{2 π}{N} \times {G}_{2} ) ∀ {G}_{2} ∈ {β}_{1} ⋀ ∀ N ∈ {ρ}_{1} ⋀ ∀ {W}_{N} ∈ \qquad ( 16 )$$

The memory location index of the ζ₂ 204 TFs vector is G₂.

The NPA-2 201 is connected to the ζ₂ 204 TFs vector that is stored in an MS 203.

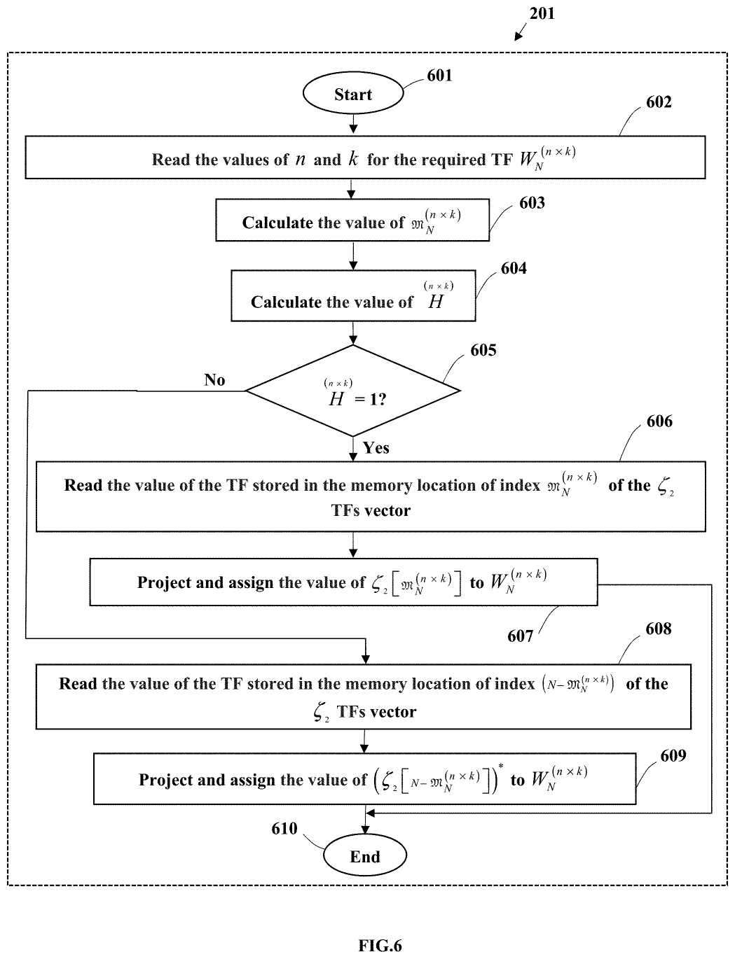

From the above equations, the NPA-2 201 of EMB-2 206 of the present invention is realized as shown in the flowchart of FIG. 6. The operation steps of the flowchart of the NPA-2 201 are presented below.

The flowchart of FIG. 6 starts at step 601, then step 602 will read the values of n and k for the required TF W_{N}^{(n×k)} 202.

Step 603 will calculate the value of [symbol] _{N}^{(n×k)} using Eq.(7).

Step 604 will calculate the value of

$${H}^{( n \times k )}$$

using Eq.(13).

Step 605 will check if

$${H}^{( n \times k )}$$

is equal to 1. If it is equal to 1, then step 606 will be executed, if it is not equal to 1, then step 608 will be executed.

Step 606 will read the value of the TF stored in the memory location of index [symbol] _{N}^{(n×k)} of the ζ₂ 204 TFs vector.

According to Eq.(17), step 607 will project and assign the value of ζ₂[ [symbol] ] to the required TF W_{N}^{(n×k)} 202.

W_{N}^{(n×k)}=ζ₂[ [symbol] ] (17)

∀n,k∈ψ\hat{ }∀ [symbol] _{N}^{(n×k)}∈β₁\hat{ }∀N∈ρ₁\hat{ }∀W_{N}∈

[symbol]

The NPA-2 201 is ended at step 610.

Step 608 will read the value of the TF stored in the memory location of index (N− [symbol] _{N}^{(n×k)}) of the ζ₂ 204 TFs vector.

According to Eq.(18), step 609 will project and assign the value of (ζ₂[N− [symbol] _{N}^{(n×k)}])* to the required TF W_{N}^{(n×k)} 202.

W_{N}^{(n×k)}=(ζ₂[N− [symbol] _{N}^{(n×k)}])* (18)

∀n,k∈ψ\hat{ }∀ [symbol] _{N}^{(n×k)}∈β₂\hat{ }∀N∈ρ₁\hat{ }∀W_{N}∈

[symbol]

The NPA-2 201 is ended at step 610.

### Embodiment-3

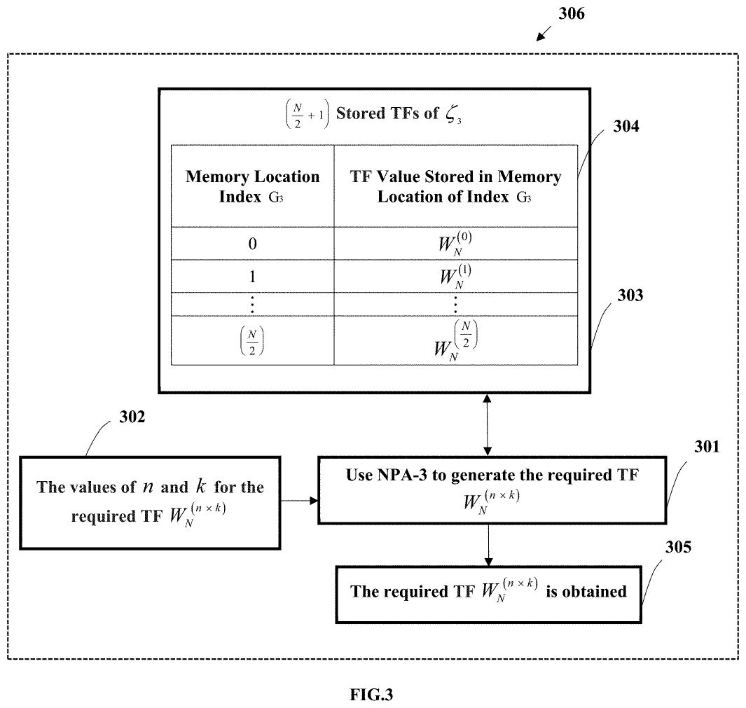

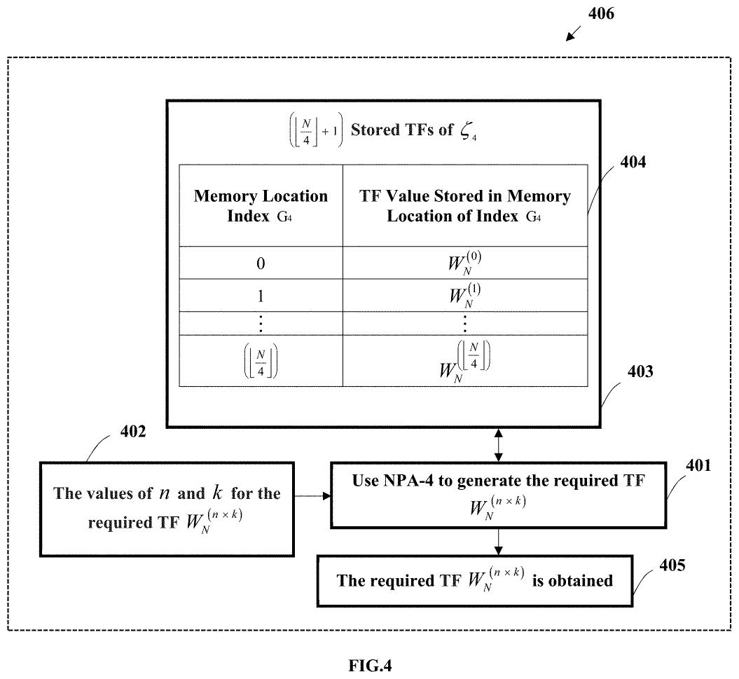

In EMB-3 306 of the present invention as shown in FIG. 3, we are going to find the formulation for the NPA-3 301 that will enable us to generate any required TF W_{N}^{(n×k)} 302.

Instead of storing the N² TFs that are needed to calculate the DFT which require large MS requirements, only

$$( \frac{N}{2} + 1 )$$

TFs that are members of the set

$${ζ}_{3} = \{ {W}_{N}^{( 0 )} , {W}_{N}^{( 1 )} , … , {W}_{N}^{( \frac{N}{2} )} \}$$

∀N∈ρ₂\hat{ }∀W_{N}∈ [symbol] are needed to be stored in an MS 303.

The NPA-3 301 will be used to project a specific value to the required TF W_{N}^{(n×k)} 302 from one of the

$$( \frac{N}{2} + 1 )$$

TFs of the ζ₃ 304 vector that is stored in an MS 303.

The outcome 305 of the NPA-3 301 will be the projected required TF W_{N}^{(n×k)} 302.

The NPA-3 301 PEs formulation is presented below.

We have the properties shown in Eq.(19), Eq.(20) and Eq.(21).

$${W}_{N}^{( ( n \times k ) ∓ \frac{N}{2} )} = - ( {W}_{N}^{( n \times k )} ) \\ ∀ n , k ∈ ψ ⋀ ∀ N ∈ {ρ}_{2} ⋀ ∀ {W}_{N} ∈ \qquad ( 19 )$$

$${W}_{N}^{( ∓ \frac{N}{2} )} = - ( {W}_{N}^{( n \times k )} ) \\ ∀ n , k , {N}_{( n \times k )}^{} ∈ ψ ⋀ ∀ N ∈ {ρ}_{2} ⋀ ∀ {W}_{N} ∈ \qquad ( 20 )$$

$${W}_{N}^{( ∓ \frac{N}{2} ) )} = - ( {W}_{N}^{( n \times k )} ) \\ ∀ n , k , {N}_{( n \times k )}^{} ∈ ψ ⋀ ∀ N ∈ {ρ}_{2} ⋀ ∀ {W}_{N} ∈ \qquad ( 21 )$$

From Eq.(8), Eq.(19), Eq.(20), and Eq.(21), we get Eq.(22).

$$\begin{matrix}{W}_{N}^{( ∓ \frac{N}{2} )} = {W}_{N}^{( + \frac{N}{2} )} \\ = {W}_{N}^{( - \frac{N}{2} )} \\ = {( {W}_{N}^{( )} )}^{⋆} \\ = {W}_{N}^{( ∓ \frac{N}{2} ) )} \\ = {W}_{N}^{( + \frac{N}{2} ) )} \\ = {W}_{N}^{( - \frac{N}{2} ) )} \\ = {W}_{N}^{( ( n \times k ) ∓ \frac{N}{2} )} \\ = {W}_{N}^{( ( n \times k ) + \frac{N}{2} )} \\ = {W}_{N}^{( ( n \times k ) - \frac{N}{2} )} \\ = - {W}_{N}^{( )} \\ = - {W}_{N}^{( n \times k )}\end{matrix} \qquad ( 22 )$$

$$∀ n , k , {N}_{( n \times k )}^{} ∈ ψ ⋀ ∀ N ∈ {ρ}_{2} ⋀ ∀ {W}_{N} ∈$$

From Eq.(12) and Eq.(22), we get Eq.(23).

$$\begin{matrix}{W}_{N}^{( n \times k )} = {W}_{N}^{( )} \\ = {( {W}_{N}^{( N - )} )}^{*} \\ = - {W}_{N}^{( + \frac{N}{2} )} \\ = - {W}_{N}^{( + \frac{N}{2} )} \\ = - {W}_{N}^{( - \frac{N}{2} )} \\ = - ( ( {W}_{N}^{{( \frac{N}{2} - )}^{*}} ) \\ = - {W}_{N}^{( {∓ \frac{N}{2} )}^{} )} \\ = - {W}_{N}^{( {+ \frac{N}{2} )}^{} )} \\ = - {W}_{N}^{( {- \frac{N}{2} )}^{} )} \\ = - {W}_{N}^{( ( n \times k ) ∓ \frac{N}{2} )} \\ = - {W}_{N}^{( ( n \times k ) + \frac{N}{2} )} \\ = - {W}_{N}^{( ( n \times k ) - \frac{N}{2} )}\end{matrix} \qquad ( 23 )$$

$$∀ n , k , \begin{matrix}{N}_{( n \times k )}^{} & ∈ ψ ⋀ ∀ N ∈ {ρ}_{2} ⋀ ∀ {W}_{N} ∈\end{matrix}$$

From Eq.(13) and Eq.(23), we get Eq.(24).

$$\begin{matrix}{W}_{N}^{( n \times k )} = - {W}_{N}^{( ( n \times k ) ∓ \frac{N}{2} )} \\ = \{ \begin{matrix}\begin{matrix}{W}_{N}^{( )} = {( {W}_{N}^{( N - )} )}^{*} = - {W}_{N}^{( ∓ \frac{N}{2} )} = \\ - {W}_{n}^{( + \frac{N}{2} )} = - {W}_{N}^{( - \frac{N}{2} )} = - ( {( {W}_{N}^{( \frac{N}{2} - )} )}^{*} ) \\ - {W}_{N}^{( {∓ \frac{N}{2} )}^{} )} = - {W}_{N}^{( {+ \frac{N}{2} )}^{} )} = - {W}_{N}^{( {- \frac{N}{2} )}^{} )}\end{matrix} \} ⇐ ∀ {H}^{( n \times k )} = 1 \\ \begin{matrix}{W}_{N}^{( )} = {( {W}_{N}^{( N - )} )}^{*} = - {W}_{N}^{( ∓ \frac{N}{2} )} = \\ - {W}_{n}^{( + \frac{N}{2} )} = - {W}_{N}^{( - \frac{N}{2} )} = - ( {( {W}_{N}^{( \frac{N}{2} - )} )}^{*} ) \\ - {W}_{N}^{( {∓ \frac{N}{2} )}^{} )} = - {W}_{N}^{( {+ \frac{N}{2} )}^{} )} = - {W}_{N}^{( {- \frac{N}{2} )}^{} )}\end{matrix} \} ⇐ ∀ {H}^{( n \times k )} = 0\end{matrix}\end{matrix} \qquad ( 24 )$$

$$∀ n , k , {N}_{( n \times k )}^{} ∈ ψ ⋀ ∀ N ∈ {ρ}_{2} ⋀ ∀ {W}_{N} ∈$$

From examining Table 2, we can clearly notice that by only storing

$$( \frac{N}{2} + 1 )$$

TFs of the ζ₃ 304 vector in an MS 303, we can generate any required TF W_{N}^{(n×k)} 302.

From Eq.(24) and Table 2, we can get Eq.(25) that shows the five PEs of EMB-3 306 that will be used to design the NPA-3 301. Equation (25) can be used to find any required TF W_{N}^{(n×k)} 302.

By using Eq.(25), we can project a specific value to the required TF W_{N}^{(n×k)} 302 from one of the

$$( \frac{N}{2} + 1 )$$

TFs of the ζ₃ 304 vector.

The MS arrangement of the NPA-3 301 is presented below.

FIG. 3 shows how the elements of the set ζ₃ are pre-calculated, arranged and stored in an MS 303 to construct the ζ₃ 304 TFs vector.

The

$$( \frac{N}{2} + 1 )$$

elements of the ζ₃ 304 TFs vector are constructed according to Eq.(26).

TABLE 2
$Does γ ∈ {Ϛ}_{3} ? \vert ∀ {H}^{( n \times k )} = 1 ⋀ ∀ {H}^{( n \times k )} = 0 ⋀ ∀ n , k , {n}_{( n \times k )}^{} ∈ ψ ⋀ ∀ N ∈ {ρ}_{2} ⋀ ∀ {W}_{N} ∈$

| # | γ | $∀ {H}^{( n \times k )} = 1$ | $∀ {H}^{( n \times k )} = 0$ |
|---|---|---|---|
| 1 | [symbol] ⁾ | Yes | No |
| 2 | ( [symbol] ⁾)* | No | Yes |
| 3 | $- {W}_{N}^{( {𝔐}_{N}^{( n \times k )} ∓ \frac{N}{2} )}$ | No | No |
| 4 | $- {W}_{N}^{( {𝔐}_{N}^{( n \times k )} + \frac{N}{2} )}$ | No | No |
| 5 | $- {W}_{N}^{( {𝔐}_{N}^{( n \times k )} - \frac{N}{2} )}$ | No | Yes |
| 6 | $- ( {( {W}_{N}^{( \frac{N}{2} {𝔐}_{N}^{( n \times k )} )} )}^{*} )$ | No | No |
| 7 | $- {W}_{N}^{( {𝔐}_{N}^{( {𝔐}_{N}^{〈 n \times k )} ∓ \frac{N}{2} )} )}$ | No | Yes |
| 8 | $- {W}_{N}^{( {𝔐}_{N}^{( {𝔐}_{N}^{〈 n \times k )} + \frac{N}{2} )} )}$ | No | Yes |
| 9 | $- {W}_{N}^{( {𝔐}_{N}^{( {𝔐}_{N}^{〈 n \times k )} - \frac{N}{2} )} )}$ | No | Yes |

$${W}_{N}^{( n \times k )} = \{ \begin{matrix}{W}_{N}^{)} & ⇐ ∀ {H}^{( n \times k )} = 1 \\ {( ) )}^{*} & ⇐ ∀ {H}^{( n \times k )} = 0 \\ - {- \frac{N}{2} )}^{} & ⇐ ∀ {H}^{( n \times k )} = 0 \\ - {+ \frac{N}{2} )}^{} ) & ⇐ ∀ {H}^{( n \times k )} = 0 \\ - {- \frac{N}{2} )}^{} ) & ⇐ ∀ {H}^{( n \times k )} = 0\end{matrix} \qquad ( 25 )$$

$$∀ n , k , {N}_{( n \times k )}^{} ∈ ψ ⋀ ∀ N ∈ {ρ}_{2} ⋀ ∀ {W}_{N} ∈$$

$${ζ}_{3} [ {G}_{3} ] = {W}_{N}^{( {G}_{3} )} = cos ( \frac{2 π}{N} \times {G}_{3} ) - j sin ( \frac{2 π}{N} \times {G}_{3} ) \\ ∀ {G}_{3} ∈ {β}_{3} = \{ 0 , 1 , … , ( \frac{N}{2} ) \} ⋀ ∀ N ∈ {ρ}_{2} ⋀ ∀ {W}_{N} ∈ \qquad ( 26 )$$

The memory location index of the ζ₃ 304 TFs vector is G₃.

The NPA-3 301 is connected to the ζ₃ 304 TFs vector that is stored in an MS 303.

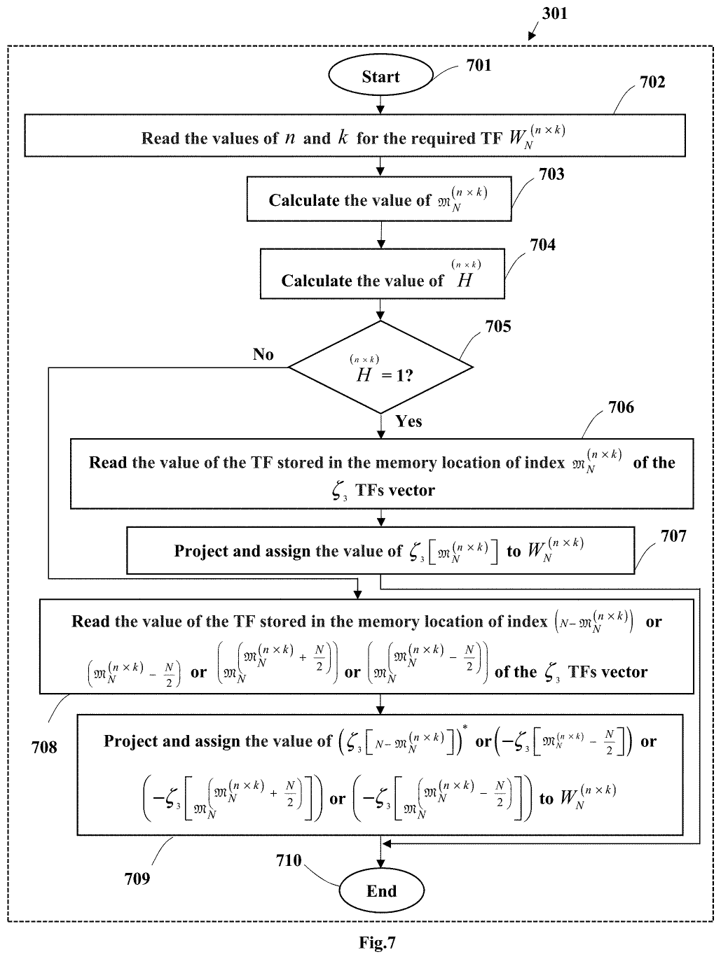

From the above equations, the NPA-3 301 of EMB-3 306 of the present invention is realized as shown in the flowchart of FIG. 7. The operation steps of the flowchart of the NPA-3 301 are presented below.

The flowchart of FIG. 7 starts at step 701, then step 702 will read the values of n and k for the required TF W_{N}^{(n×k)} 302.

Step 703 will calculate the value of [symbol] _{N}^{(n×k)} using Eq.(7).

Step 704 will calculate the value of

$${H}^{( n \times k )}$$

using Eq.(13).

Step 705 will check if

$${H}^{( n \times k )}$$

is equal to 1. If it is equal to 1, then step 706 will be executed, if it is not equal to 1, then step 708 will be executed.

Step 706 will read the value of the TF stored in the memory location of index [symbol] _{N}^{(n×k)} of the ζ₃ 304 TFs vector.

According to Eq.(27), step 707 will project and assign the value of ζ₃[ [symbol] _{N}^{(n×k)}] to the required TF W_{N}^{(n×k)} 302.

W_{N}^{(n×k)}=ζ₃[ [symbol] _{N}^{(n×k)}] (27)

∀n,k,∈ψ\hat{ }∀ [symbol] _{N}^{(n×k)}∈β₃\hat{ }∀N∈ρ₂\hat{ }∀W_{N}∈

[symbol]

The NPA-3 301 is ended at step 710.

Step 708 will read the value of the TF stored in the memory location of index (N− [symbol] _{N}^{(n×k)}) or

$$( {N}_{( n \times k )}^{} - \frac{N}{2} ) or ( {+ \frac{N}{2} )}^{} ) or ( {- \frac{N}{2} )}^{} )$$

of the ζ₃ 304 TFs vector.

According to Eq.(28), step 709 will project and assign the value of (ζ₃[N− [symbol] _{N}^{(n×k)}])* or

$$( - {ζ}_{3} [ {N}_{( n \times k )}^{} - \frac{N}{2} ] ) or ( - {ζ}_{3} [ {+ \frac{N}{2} )}^{} ] ) or ( - {ζ}_{3} [ {- \frac{N}{2} )}^{} ] )$$

to the required W_{N}^{(n×k)} 302.

$${W}_{N}^{( n \times k )} = {( {ζ}_{3} [ N - {N}_{( n \times k )}^{} ] )}^{*} = - {ζ}_{3} [ {N}_{( n \times k )}^{} - \frac{N}{2} ] = - {ζ}_{3} [ {+ \frac{N}{2} )}^{} ] = - {ζ}_{3} [ {- \frac{N}{2} )}^{} ] \qquad ( 28 )$$

$$∀ n , k ∈ ψ ⋀ {N}_{( n \times k )}^{} ∈ {β}_{4} = \{ ( \frac{N}{2} + 1 ) , ( \frac{N}{2} + 2 ) , … , ( N - 1 ) \} ⋀ ∀ N ∈ {ρ}_{2} ⋀ ∀ {W}_{N} ∈$$

The NPA-3 301 is ended at step 710.

### Embodiment-4

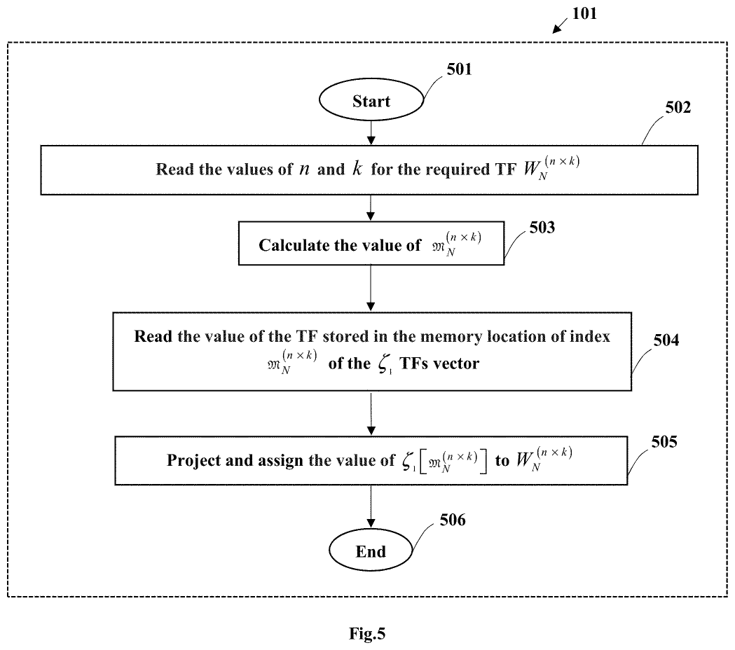

In EMB-4 406 of the present invention as shown in FIG. 4, we are going to find the formulation for the NPA-4 401 that will enable us to generate any required TF W_{N}^{(n×k)} 402.

Instead of storing the N² TFs that are needed to calculate the DFT which require large MS requirements, only

$$( ⌊ \frac{N}{4} ⌋ + 1 )$$

TFs that are members of the set

$${Ϛ}_{4} = \{ {W}_{N}^{( 0 )} , {W}_{N}^{( 1 )} , … , {W}_{N}^{( ⌊ \frac{N}{4} ⌋ )} \} ∀ N ∈ {ρ}_{2} ⋀ ∀ {W}_{N} ∈$$

are needed to be stored in an MS 403.

The NPA-4 401 will be used to project a specific value to the required TF W_{N}^{(n×k)} 402 from one of the

$$( ⌊ \frac{N}{4} ⌋ + 1 )$$

TFs of the ζ₄ 404 vector that is stored in an MS 403.

The outcome 405 of the NPA-4 401 will be the projected required TF W_{N}^{(n×k)} 402.

The NPA-4 401 PEs formulation is presented below.

Let be

$${Q}^{( n \times k )}$$

defined as in Eq.(29).

$${Q}^{( n \times k )} = ⌊ ⌋ \\ ∀ n , k , {N}_{( n \times k )}^{} ∈ ψ ⋀ ∀ N ∈ {ρ}_{2} \qquad ( 29 )$$

From Eq.(29), the computation of

$${Q}^{( n \times k )}$$

will result one of the values shown in Eq.(30).

$${Q}^{( n \times k )} = \{ \begin{matrix}0 & ⇐ ∀ {N}_{( n \times k )}^{} ∈ {λ}_{1} = \{ 0 , 1 , 2 , … , ⌊ \frac{N}{4} ⌋ \} \\ 1 & ⇐ ∀ {N}_{( n \times k )}^{} ∈ {λ}_{2} = \{ ( ⌊ \frac{N}{4} ⌋ + 1 ) , ( ⌊ \frac{N}{4} ⌋ + 2 ) , … , ⌊ \frac{N}{2} ⌋ \} \\ 2 & ⇐ ∀ {N}_{( n \times k )}^{} ∈ {λ}_{3} = \{ ( ⌊ \frac{N}{2} ⌋ + 1 ) , ( ⌊ \frac{N}{2} ⌋ + 2 ) , … , ⌊ \frac{( 3 \times N )}{4} ⌋ \} \\ 3 & ⇐ ∀ {N}_{( n \times k )}^{} ∈ {λ}_{4} = \{ ( ⌊ \frac{( 3 \times N )}{4} ⌋ + 1 ) , ( ⌊ \frac{( 3 \times N )}{4} ⌋ + 2 ) , … , ( N - 1 ) \}\end{matrix} \qquad ( 30 )$$

$$∀ n , k , {N}_{( n \times k )}^{} ∈ ψ ⋀ ∀ N ∈ {ρ}_{2}$$

From Eq.(24), we can get Eq.(31).

From examining Table 3, we can clearly notice that by only storing

$$( ⌊ \frac{N}{4} ⌋ + 1 )$$

TFs of the ζ₄ 404 vector in an MS 403, we can generate any required TF W_{N}^{(n×k)} 402.

TABLE 3
$Does φ ∈ {Ϛ}_{4} ? \vert ( ∀ {Q}^{( n \times k )} ∈ \{ 0 , 1 , 2 , 3 \} ) ⋀ ( ∀ n , k , {N}_{( n \times k )}^{} ∈ ψ ⋀ ∀ N ∈ {ρ}_{2} ⋀ {W}_{N} ∈ )$

| # | φ | $∀ {Q}^{( n \times k )} = 0$ | $∀ {Q}^{( n \times k )} = 1$ | $∀ {Q}^{( n \times k )} = 2$ | $∀ {Q}^{( n \times k )} = 3$ |
|---|---|---|---|---|---|
| 1 | [symbol] | Yes | No | No | No |
| 2 | ( [symbol] )* | No | No | No | Yes |
| 3 | $- {W}_{N}^{( {N}_{( n \times k )}^{} ∓ \frac{N}{2} )}$ | No | No | No | No |
| 4 | $- {W}_{N}^{( {N}_{( n \times k )}^{} + \frac{N}{2} )}$ | No | No | No | No |
| 5 | $- {W}_{N}^{( {N}_{( n \times k )}^{} - \frac{N}{2} )}$ | No | No | Yes | No |
| 6 | $- ( {( {W}_{N}^{( \frac{N}{2} - {N}_{( n \times k )}^{} )} )}^{*} )$ | No | Yes | No | No |
| 7 | $- {W}_{N}^{( {N}_{( {N}_{{〈 n \times k )}_{∓}}^{} \frac{N}{2} )}^{} )}$ | No | No | Yes | No |
| 8 | $- {W}_{N}^{( {N}_{( {N}_{{〈 n \times k )}_{+}}^{} \frac{N}{2} )}^{} )}$ | No | No | Yes | No |
| 9 | $- {W}_{N}^{( {N}_{( {N}_{{〈 n \times k )}_{-}}^{} \frac{N}{2} )}^{} )}$ | No | No | Yes | No |

From Eq.(31) and Table 3, we can get Eq.(32) that shows the six PEs of EMB-4 406 which will be used to design the NPA-4 401. Equation (32) can be used to find any required TF W_{N}^{(n×k)} 402.

$${W}_{N}^{( n \times k )} = \{ \begin{matrix} & ⇐ ∀ {Q}^{( n \times k )} = 0 \\ - ( {( )}^{*} ) & ⇐ ∀ {Q}^{( n \times k )} = 1 \\ - {- \frac{N}{2} )}^{} & ⇐ ∀ {Q}^{( n \times k )} = 2 \\ - {+ \frac{N}{2} ) )}^{} & ⇐ ∀ {Q}^{( n \times k )} = 2 \\ - {- \frac{N}{2} ) )}^{} & ⇐ ∀ {Q}^{( n \times k )} = 2 \\ {( )}^{*} & ⇐ ∀ {Q}^{( n \times k )} = 3\end{matrix} \qquad ( 32 )$$

$$∀ n , k , {N}_{( n \times k )}^{} ∈ ψ ⋀ ∀ N ∈ {ρ}_{4} ⋀ ∀ {W}_{N} ∈$$

By using Eq.(32), we can project a specific value to the required TF W_{N}^{(n×k)} 402 from one of the

$$( ⌊ \frac{N}{4} ⌋ + 1 )$$

TFs of the ζ₄ 404 vector.

The MS arrangement of the NPA-4 401 is presented below.

FIG. 4 shows how the elements of the set ζ₄ are pre-calculated, arranged and stored in an MS 403 to construct the ζ₄ 404 TFs vector.

The

$$( ⌊ \frac{N}{4} ⌋ + 1 )$$

elements of the ζ₄ 404 TFs vector are constructed according to Eq.(33).

$${ζ}_{4} [ {G}_{4} ] = {W}_{N}^{( {G}_{4} )} = cos ( \frac{2 π}{N} \times {G}_{4} ) - j sin ( \frac{2 π}{N} \times {G}_{4} ) ∀ {G}_{4} ∈ {λ}_{1} ⋀ ∀ N ∈ {ρ}_{2} ⋀ ∀ {W}_{N} ∈ \qquad ( 33 )$$

The memory location index of the ζ₄ 404 TFs vector is G₄.

The NPA-4 401 is connected to the ζ₄ 404 TFs vector that is stored in an MS 403.

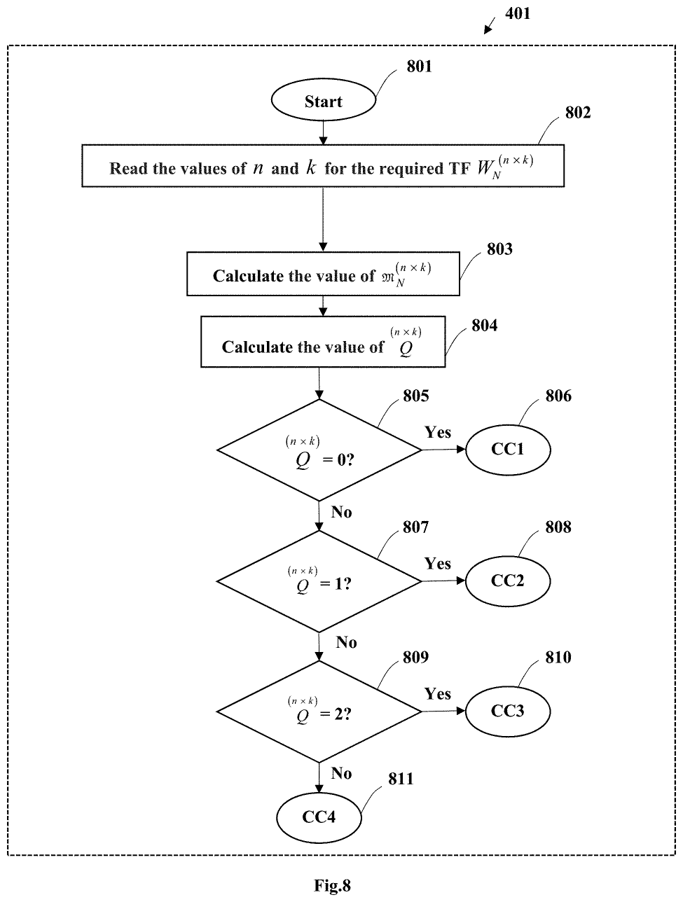

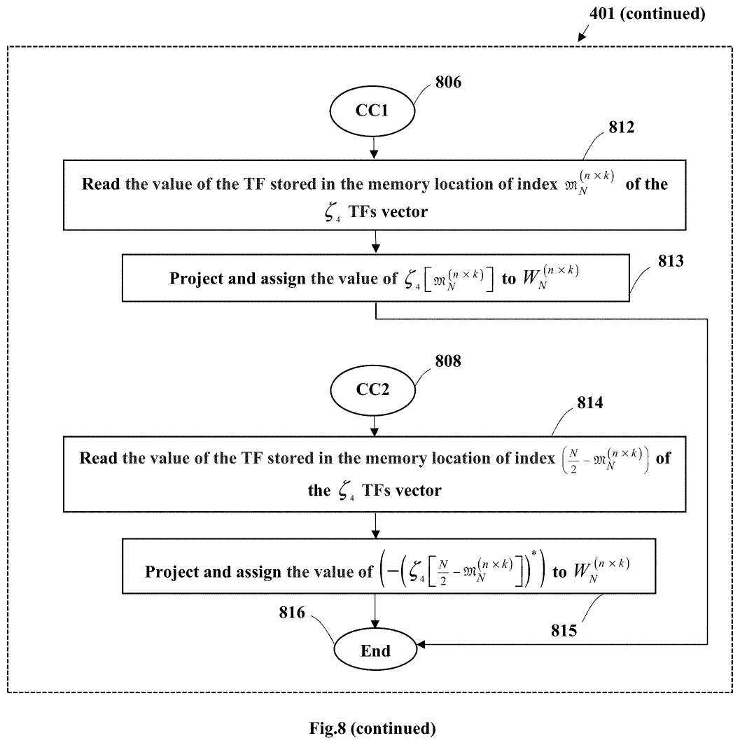

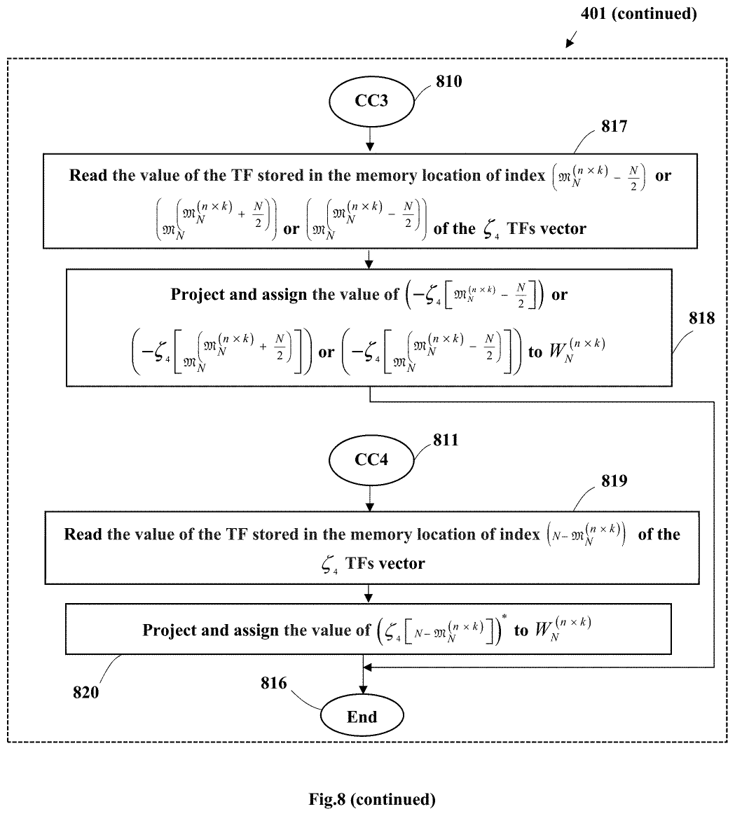

From the above equations, the NPA-4 401 of EMB-4 406 of the present invention is realized as shown in the flowchart of FIG. 8. The operation steps of the flowchart of the NPA-4 401 are presented below.

The flowchart of FIG. 8 starts at step 801, then step 802 will read the values of n and k for the required TF W_{N}^{(n×k)} 402.

Step 803 will calculate the value of [symbol] _{N}^{(n×k)} using Eq.(7).

Step 804 will calculate the value of

$${Q}^{( n \times k )}$$

using Eq.(29).

Step 805 will check if

$${Q}^{( n \times k )}$$

is equal to 0. If it is equal to 0, then the path of connector CC1 806 will be followed and step 812 will be executed. If it is not equal to 0, then step 807 will be executed.

Connector CC1 806 is connecting step 805 and step 812.

Step 807 will check if

$${Q}^{( n \times k )}$$

is equal to 1. If it is equal to 1, then the path of connector CC2 808 will be followed and step 814 will be executed. If it is not equal to 1, then step 809 will be executed.

Connector CC2 808 is connecting step 807 and step 814.

Step 809 will check if

$${Q}^{( n \times k )}$$

is equal to 2. If it is equal to 2, then the path of connector CC3 810 will be followed and step 817 will be executed. If it is not equal to 2, meaning that

$${Q}^{( n \times k )}$$

is equal to 3, then the path of connector CC4 811 will be followed and step 819 will be executed.

Connector CC3 810 is connecting step 809 and step 817.

Connector CC4 811 is connecting step 809 and step 819.

Step 812 will read the value of the TF stored in the memory location of index [symbol] _{N}^{(n×k)} of the ζ₄ 404 TFs vector.

According to Eq.(34), step 813 will project and assign the value of ζ₄[ [symbol] _{N}^{(n×k)}] to the required TF W_{N}^{(n×k)} 402.

W_{N}^{(n×k)}=ζ₄[ [symbol] _{N}^{(n×k)}] (34)

∀n,k,∈ψ\hat{ }∀ [symbol] _{N}^{(n×k)}∈λ₁\hat{ }∀N∈ρ₂\hat{ }∀W_{N}∈

[symbol]

The NPA-4 401 is ended at step 816.

Step 814 will read the value of the TF stored in the memory location of index

$$( \frac{N}{2} - {N}_{( n \times k )}^{} )$$

of the ζ₄ 404 TFs vector.

According to Eq.(35), step 815 will project and assign the value of

$$( - {( {ζ}_{4} [ \frac{N}{2} - {𝔐}_{N}^{( n \times k )} ] )}^{*} )$$

to the required TF W_{N}^{(n×k)} 402.

$${W}_{N}^{( n \times k )} = ( - {( {ζ}_{4} [ \frac{N}{2} - {N}_{( n \times k )}^{} ] )}^{*} ) \\ ∀ n , k ∈ ψ ⋀ ∀ {N}_{( n \times m )}^{} ∈ {λ}_{2} ⋀ ∀ N ∈ {ρ}_{2} ⋀ ∀ {W}_{N} ∈ \qquad ( 35 )$$

The NPA-4 401 is ended at step 816.

Step 817 will read the value of the TF stored in the memory location of index

$$( {N}_{( n \times k )}^{} - \frac{N}{2} ) or ( {N}_{( {N}_{( n \times k )}^{} + \frac{N}{2} )}^{} ) or ( {N}_{( {N}_{( n \times k )}^{} - \frac{N}{2} )}^{} )$$

of the ζ₄ 404 TFs vector.

According to Eq.(36), step 818 will project and assign the value of

$$( - {ζ}_{4} [ {N}_{( n \times k )}^{} - \frac{N}{2} ] ) or ( - {ζ}_{4} [ {N}_{( {N}_{( n \times k )}^{} + \frac{N}{2} )}^{} ] ) \\ or \\ ( - {ζ}_{4} [ {N}_{( {N}_{( n \times k )}^{} - \frac{N}{2} )}^{} ] )$$

to the required TF W_{N}^{(n×k)} 402.

$${W}_{N}^{( n \times k )} = ( - {ζ}_{4} [ {N}_{( n \times k )}^{} - \frac{N}{2} ] ) = ( - {ζ}_{4} [ {N}_{( {N}_{( n \times k )}^{} + \frac{N}{2} )}^{} ] ) = ( - {ζ}_{4} [ {N}_{( {N}_{( n \times k )}^{} - \frac{N}{2} )}^{} ] ) ∀ n , k ∈ ψ ⋀ ∀ {N}_{( n \times k )}^{} ∈ {λ}_{3} ⋀ ∀ N ∈ {ρ}_{2} ⋀ ∀ {W}_{N} ∈ \qquad ( 36 )$$

The NPA-4 401 is ended at step 816.

Step 819 will read the value of the TF stored in the memory location of index (N− [symbol] _{N}^{(n×k)}) of the ζ₄ 404 TFs vector.

According to Eq.(37), step 820 will project and assign the value of (ζ₄[N− [symbol] _{N}^{(n×k)}])* to the required TF W_{N}^{(n×k)} 402.

W_{N}^{(n×k)}=(ζ₄[N− [symbol] _{N}^{(n×k)}])* (37)

∀n,k∈ψ\hat{ }∀ [symbol] _{N}^{(n×k)}∈λ₄\hat{ }∀N∈ρ₂\hat{ }∀W_{N}∈

[symbol]

The NPA-4 401 is ended at step 816.

Performance Evaluation

The TPR is the percentage ratio of the MNRTF that is needed to be stored in an MS 103 or MS 203 or MS 303 or MS 403 to the N² total TFs needed to calculate the DFT as shown in Eq.(38).

$$TPR = ( \frac{M N R T F}{{N}^{2}} ) \times 100 \% \\ ∀ N ∈ {ρ}_{1} \qquad ( 38 )$$

From Eq.(38), the PMRR for the memory requirements for storing the TFs that are needed to calculate the DFT is shown in Eq.(39).

$$PMRR = ( 1 - \frac{MNRTF}{{N}^{2}} ) \times 100 \% \\ ∀ N ∈ {ρ}_{1} \qquad ( 39 )$$

Table 4 presents a comparison between the NPA-1 101 of EMB-1 106, the NPA-2 201 of EMB-2 206, the NPA-3 301 of EMB-3 306, the NPA-4 401 of EMB-4 406 of the present invention and the DFT regarding their MNRTF, TPR, PMRR, the number of samples in the time domain N to be transformed to frequency domain using DFT and the number of their PEs.

From Table 4, it is clear to notice that the NPA-4 401 of EMB-4 406 that works for ∀N∈ρ₂ has the lowest MNRTF, lowest TPR and the highest PMRR. So, it has a better performance when compared with the performance of the NPA-1 101 of EMB-1 106, the NPA-2 201 of EMB-2 206, the NPA-3 301 of EMB-3 306 of the present invention and the DFT.

From Table 4, it is clear to notice that the NPA-2 201 of EMB-2 206 that works ∀N∈ρ₁ and the NPA-3 301 of EMB-3 306 that works ∀N∈ρ₂ have the same MNRTF, the same TPR and the same PMRR when compared ∀N∈ρ₂.

From Table 4, it is clear to notice that the DFT has the highest MNRTF, highest TPR and the lowest PMRR. So it has the lowest performance when compared with the performance of the NPA-1 101 of EMB-1 106 that works ∀N∈ρ₁, the NPA-2 201 of EMB-2 206 that works ∀N∈ρ₁, the performance of the NPA-3 301 of EMB-3 306 that works ∀N∈ρ₂, and the NPA-4 401 of EMB-4 406 that works ∀N∈ρ₂.

TABLE 4

| | | | | | Number of |
|---|---|---|---|---|---|
| NPA No./ | | | | | Projection |
| Type | MNRTF | TPR | PMRR | N is: | Equations |
| 1 | N | $( \frac{1}{N} ) \times 100 \%$ | $( 1 - \frac{1}{N} ) \times 100 \%$ | Odd or Even | 1 |
| 2 | $( ⌊ \frac{N}{2} ⌋ + 1 )$ | $( \frac{( ⌊ \frac{N}{2} ⌋ + 1 )}{{N}^{2}} ) \times 100 \%$ | $( 1 - \frac{( ⌊ \frac{N}{2} ⌋ + 1 )}{{N}^{2}} ) \times 100 \%$ | Odd or Even | 2 |
| 3 | $( \frac{N}{2} + 1 )$ | $( \frac{( \frac{N}{2} + 1 )}{{N}^{2}} ) \times 100 \%$ | $( 1 - \frac{( \frac{N}{2} + 1 )}{{N}^{2}} ) \times 100 \%$ | Even | 5 |
| 4 | $( ⌊ \frac{N}{4} ⌋ + 1 )$ | $( \frac{( ⌊ \frac{N}{4} ⌋ + 1 )}{{N}^{2}} ) \times 100 \%$ | $( 1 - \frac{( ⌊ \frac{N}{4} ⌋ + 1 )}{{N}^{2}} ) \times 100 \%$ | Even | 6 |
| DFT | N² | 100% | 0% | Odd or | — |
| | | | | Even | |

From Table 4, it is clear to notice that the NPA-1 101 of EMB-1 106 that works ∀N∈ρ₁ has the highest MNRTF, the highest TPR and the lowest PMRR. So, it has the lowest performance when compared with the performance of the NPA-2 201 of EMB-2 206 that works ∀N∈ρ₁, the performance of the NPA-3 301 of EMB-3 306 that works ∀N∈ρ₂, and the performance of the NPA-4 401 of EMB-4 406 that works ∀N∈ρ₂.

Having a low MNRTF is highly recommended since it will result in low MS requirements for the TFs that will have to be stored in an MS 103 or MS 203 or MS 303 or MS 403 and to be used by the NPA-1 101 of EMB-1 106, the NPA-2 201 of EMB-2 206, the NPA-3 301 of EMB-3 306 and the NPA-4 401 of EMB-4 406 respectively to generate any required TF of the DFT matrix.

A low MNRTF results in a low power consumption. It is desired to have a low MNRTF that will result in a low TPR. Also, it will result in a high PMRR that is also desired. A high MNRTF is not desired since it will result in a high TPR and a low PMRR.

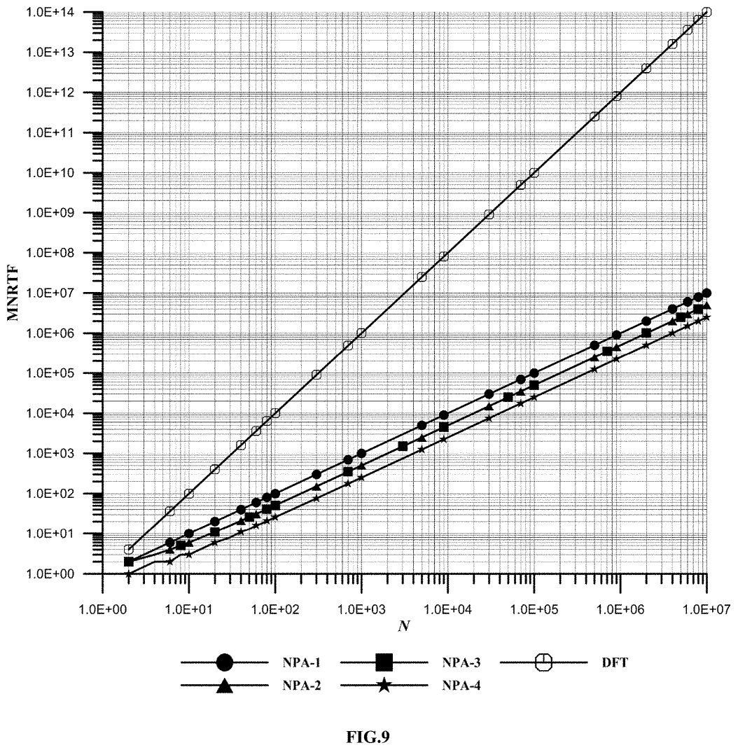

FIG. 9 shows the simulated comparison results plot of the MNRTF computations (logarithmic scale) versus the number of points N (logarithmic scale) for the NPA-1 101 of EMB-1 106, the NPA-2 201 of EMB-2 206, the NPA-3 301 of EMB-3 306, the NPA-4 401 of EMB-4 406 of the present invention and the DFT.

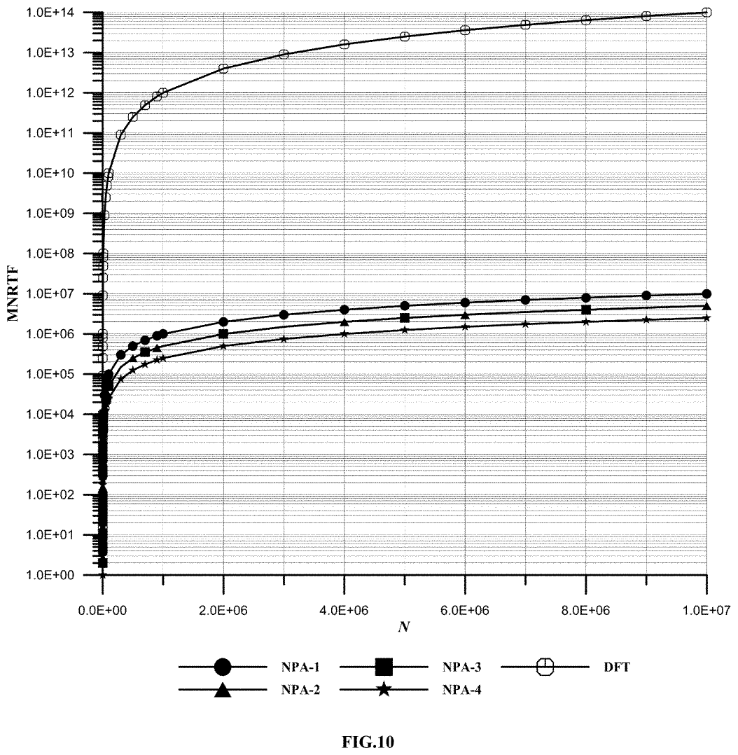

FIG. 10 shows the simulated comparison results plot of the MNRTF computations (logarithmic scale) versus the number of points N (linear scale) for the NPA-1 101 of EMB-1 106, the NPA-2 201 of EMB-2 206, the NPA-3 301 of EMB-3 306, the NPA-4 401 of EMB-4 406 of the present invention and the DFT.

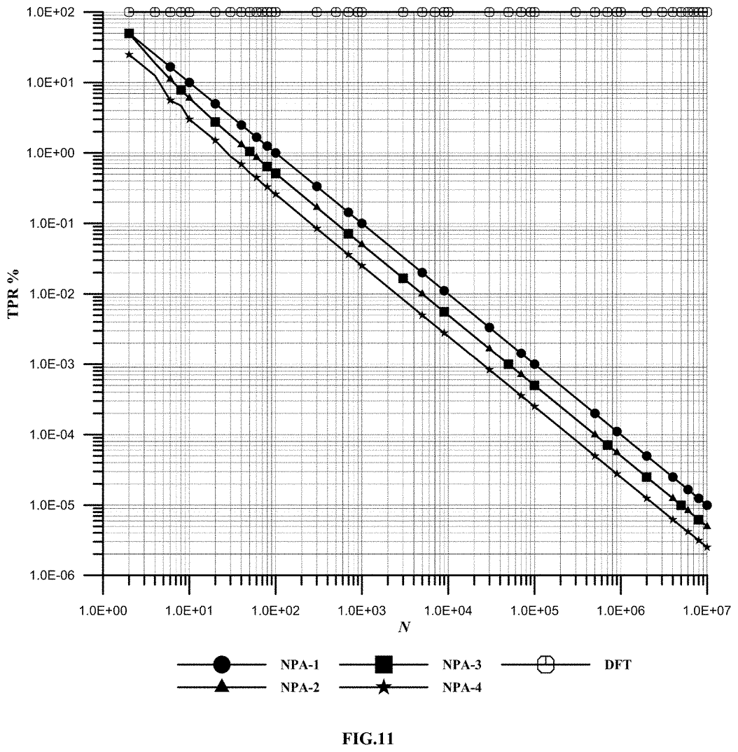

FIG. 11 shows the simulated comparison results plot of the TPR of the MNRTF computations (logarithmic scale) versus the number of points N (logarithmic scale) for the NPA-1 101 of EMB-1 106, the NPA-2 201 of EMB-2 206, the NPA-3 301 of EMB-3 306, the NPA-4 401 of EMB-4 406 of the present invention and the DFT.

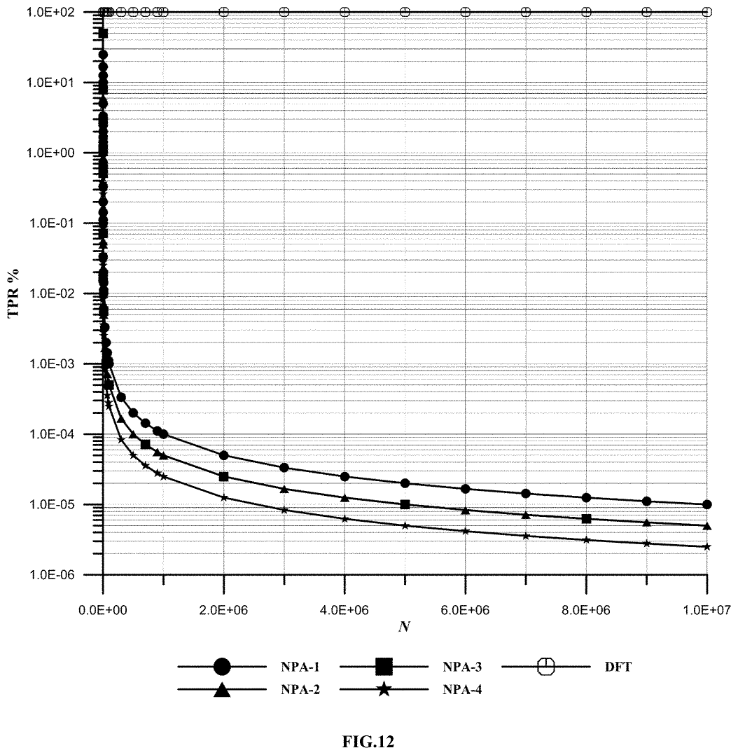

FIG. 12 shows the simulated comparison results plot of the TPR of the MNRTF computations (logarithmic scale) versus the number of points N (linear scale) for the NPA-1 101 of EMB-1 106, the NPA-2 201 of EMB-2 206, the NPA-3 301 of EMB-3 306, the NPA-4 401 of EMB-4 406 of the present invention and the DFT.

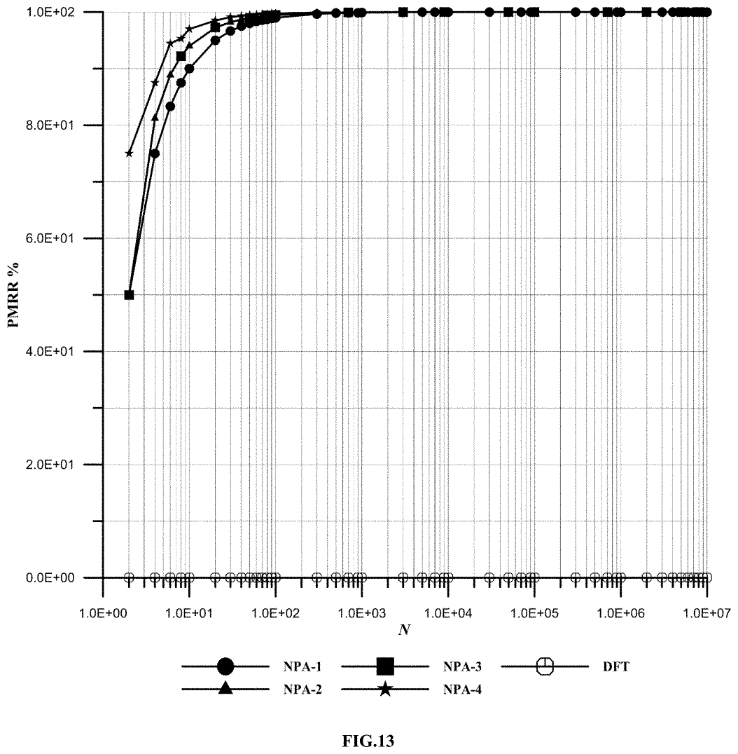

FIG. 13 shows the simulated comparison results plot of the PMRR computations (linear scale) versus the number of points N (logarithmic scale) for the NPA-1 101 of EMB-1 106, the NPA-2 201 of EMB-2 206, the NPA-3 301 of EMB-3 306, the NPA-4 401 of EMB-4 406 of the present invention and the DFT.

For the IDFT, the IDFT matrix form of Eq. (2) is shown in Eq.(40).

$$[ \begin{matrix}{x}_{0} \\ {x}_{1} \\ {x}_{2} \\ ⋮ \\ {x}_{N - 1}\end{matrix} ] = [ \text{} \begin{matrix}{W}_{N}^{( - ( 0 \times 0 ) )} & {W}_{N}^{( - ( 0 \times 1 ) )} & {W}_{N}^{( - ( 0 \times 2 ) )} & … & {W}_{N}^{( - ( 0 \times ( N - 1 ) ) )} \\ {W}_{N}^{( - ( 1 \times 0 ) )} & {W}_{N}^{( - ( 1 \times 1 ) )} & {W}_{N}^{( - ( 1 \times 2 ) )} & … & {W}_{N}^{( - ( 1 \times ( N - 1 ) ) )} \\ {W}_{N}^{( - ( 2 \times 0 ) )} & {W}_{N}^{( - ( 2 \times 1 ) )} & {W}_{N}^{( - ( 2 \times 2 ) )} & … & {W}_{N}^{( - ( 2 \times ( N - 1 ) ) )} \\ ⋮ & ⋮ & ⋮ & ⋱ & ⋮ \\ {W}_{N}^{( - ( ( N - 1 ) \times 0 ) )} & {W}_{N}^{( - ( ( N - 1 ) \times 1 ) )} & {W}_{N}^{( - ( ( N - 1 ) \times 2 ) )} & … & {W}_{N}^{( - ( ( N - 1 ) \times ( N - 1 ) ) )}\end{matrix} ] \times [ \text{} \begin{matrix}{X}_{0} \\ {X}_{1} \\ {X}_{2} \\ ⋮ \\ {X}_{N - 1}\end{matrix} ] \\ ∀ X , x , {W}_{N} ∈ ⋀ ∀ N ∈ {ρ}_{1} \qquad ( 40 )$$

From Eq.(40), we can get the compact IDFT matrix form of the IDFT as shown in Eq.(41).

$$[ \begin{matrix}{x}_{0} \\ {x}_{1} \\ {x}_{2} \\ ⋮ \\ {x}_{N - 1}\end{matrix} ] = [ \text{} \begin{matrix}{W}_{N}^{( 0 )} & {W}_{N}^{( 0 )} & {W}_{N}^{( 0 )} & … & {W}_{N}^{( 0 )} \\ {W}_{N}^{( 0 )} & {W}_{N}^{( - 1 )} & {W}_{N}^{( - 2 )} & … & {W}_{N}^{( - ( 1 \times ( N - 1 ) ) )} \\ {W}_{N}^{( 0 )} & {W}_{N}^{( - 2 )} & {W}_{N}^{( - 4 )} & … & {W}_{N}^{( - ( 2 \times ( N - 1 ) ) )} \\ ⋮ & ⋮ & ⋮ & ⋱ & ⋮ \\ {W}_{N}^{( 0 )} & {W}_{N}^{( - ( ( N - 1 ) \times 1 ) )} & {W}_{N}^{( - ( ( N - 1 ) \times 2 ) )} & … & {W}_{N}^{( - ( ( N - 1 ) \times ( N - 1 ) ) )}\end{matrix} ] \times [ \text{} \begin{matrix}{X}_{0} \\ {X}_{1} \\ {X}_{2} \\ ⋮ \\ {X}_{N - 1}\end{matrix} ] \\ ∀ X , x , {W}_{N} ∈ ⋀ ∀ N ∈ {ρ}_{1} \qquad ( 41 )$$

From Eq.(1), Eq.(2), Eq.(5) and Eq.(41), we can easily conclude that the NPA-1 101 of EMB-1 106, the NPA-2 201 of EMB-2 206, the NPA-3 301 of EMB-3 306 and the NPA-4 401 of EMB-4 406 of the present invention can also be easily adapted and used to calculate the TFs needed to calculate the IDFT.

The relation between the TF W_{N}^{(-(n×k))}|_{IDFT} ∀n,k∈ψ\hat{ }∀N∈ρ₁\hat{ }∀W_{N}∈ [symbol] and the TF W_{N}^{(n×k))}|_{DFT} ∀n,k∈ψ\hat{ }∀N∈ρ₁\hat{ }∀W_{N}∈ [symbol] is shown in Eq.(42).

W_{N}^{(-(n×k))}|_{IDFT}=(W_{N}^{(n×k)})*|_{DFT} (42)

∀n,k∈ψ\hat{ }∀N∈ρ₁\hat{ }∀W_{N}∈

[symbol]

### REFERENCES

### U.S. Patent Documents

| | | | |
|---|---|---|---|
| US 2009/ | Oct. 2009 | Christopher D. Moffatt, | 370/208, 375/260 |
| 0245084 A1 | | Anders Mattsson, | |
| | | John W. Pajunen | |

### Foreign Documents

| | | | |
|---|---|---|---|
| A New Relation | Jul. 2015 | Jozsef Suto, | ELEKTRONIKA IR |
| between “Twiddle | | Stefan Oniga | ELEKTROTECHNIKA, ISSN 1392- |
| Factors” in the Fast | | | 1215, VOL. 21, NO. 4, 2015, |
| Fourier | | | DOI: 10.5755/j01.eee.21.4.12784 |
| Transformation | | | |

1. A new DFT TFs projection algorithms comprising the NPA-1 101 of EMB-1 106, the NPA-2 201 of EMB-2 206, the NPA-3 301 of EMB-3 306 and the NPA-4 401 of EMB-4 406 are presented to generate any required IT of the DFT matrix by providing only a small portion of the TFs that are stored in an MS.

2. The present invention presents how to exploit the existence of symmetries and similarities among the TFs of the DFT matrix to construct a methodology of operation to be able to formulate the DFT TFs NPAs of claim 1.

3. The DFT TFs NPAs of claim 1 will generate any required TF of the DFT matrix that will avoid the need of retrieving that TF from pre-saved lookup tables of the DFT matrix and also will avoid the need to calculate it with slow complicated algorithms like CORDIC as used by prior arts.

4. The DFT TFs NPAs of claim 1 are very efficient due to their low MS requirements, high speed and low power consumption. Such efficiency is vital for real time computation of the DFT with large number of samples in the time domain to be transformed to frequency domain.

5. The NPA-1 101 of EMB-1 106 of claim 1 will require only N stored TFs in an MS to generate any required TF of the N² DFT matrix that will reduce the MS requirements by a factor of
$$( 1 - \frac{1}{N} ) \times 100 \% .$$
The NPA-1 works for any odd or even value of N.

6. The NPA-2 201 of EMB-2 206 of claim 1 requires only
$$( ⌊ \frac{N}{2} ⌋ + 1 )$$
stored TFs in an MS to generate any required TF of the N² DFT matrix that will reduce the MS requirements by a factor of
$$( 1 - \frac{( ⌊ \frac{N}{2} ⌋ + 1 )}{{N}^{2}} ) \times 100 \% .$$
The NPA-2 works for any odd or even value of N.

7. The NPA-3 301 of EMB-3 306 of claim 1 requires only
$$( \frac{N}{2} + 1 )$$
stored TFs in an MS to generate any required TF of the N² DFT matrix that will reduce the MS requirements by a factor of
$$( 1 - \frac{( \frac{N}{2} + 1 )}{{N}^{2}} ) \times 100 \% .$$
The NPA-3 works only for any even value of N.

8. The NPA-4 401 of EMB-4 406 of claim 1 requires only
$$( ⌊ \frac{N}{4} ⌋ + 1 )$$
stored TFs in an MS to generate any required TF of the N² DFT matrix that will reduce the MS requirements by a factor of
$$( 1 - \frac{( ⌊ \frac{N}{4} ⌋ + 1 )}{{N}^{2}} ) \times 100 \% .$$
The NPA-4 works only for any even value of N.

9. The DFT TFs NPAs of claim 1 including the NPA-1 101 of EMB-1 106, the NPA-2 201 of EMB-2 206, the NPA-3 301 of EMB-3 306 and the NPA-4 401 of EMB-4 406 can also be easily adapted and used to calculate the TFs needed to calculate the IDFT.
